(19) United States
(12) Patent Application Publication
(10) Pub. No.: US 2009/0295271 A1
(43) Pub. Date: Dec. 3, 2009

(54) Field Emission Display Having Multi-Layer Structure

(75) Inventors: Ningsheng Xu, Guangdong Province (CN); Jun Chen, Guangdong Province (CN); Yiyi Dai, Guangdong Province (CN); Shaozhi Deng, Guangdong Province (CN); Juncong She, Guangdong Province (CN)

Correspondence Address: SCHMEISER, OLSEN & WATTS, 22 CENTURY HILL DRIVE, SUITE 302, LATHAM, NY, 12110, US

(73) Assignee: ZHONGSHAN UNIVERSITY, Guangzhou, Guangdong (CN)

(21) Appl. No.: 11/886,817

(22) PCT Filed: Apr. 1, 2005
(86) PCT No.: PCT/CN2005/000432

§ 371 Date: Jun. 19, 2009

(51) Int. Cl. H01J 63/04

(52) U.S. Cl. 313/496

(57) ABSTRACT

A field emission display having multi-layer structure is composed of three separate plates, i.e. a cathode plate, a gate plate and an anode plate. Cathodes are prepared on the cathode plates. Gate apertures are fabricated on the gate plate. Gate electrodes and focusing electrodes are fabricated on the gate plate. Phosphor layer is prepared on the anode plate. These plates are assembled together and electrically insulated from each other by insulating spacers, forming a field emission display.

### TECHNOLOGY FIELD OF THE INVENTION

The present invention relates to displays, to be specific, a field emission display having multi-layer structure.

### DESCRIPTION OF THE PRIOR ART

Flat panel display devices are widely used for their light weight and thin structure, and the common flat panel displays include liquid crystal displays (LCD), plasma display panels(PDP), electroluminescent (EL) displays, and field emission displays (FED) and so on. Among them, because of its high-definition and lower power consumption, LCD has occupied the whole display market for notebook computers and partial display market for desktop computers. But it is not the ideal display due to the high cost and long response time. Plasma Display Panels have a shorter lifetime and their image quality will decrease after certain working period.

Using cold-cathode arrays as its electron source, a field emission display (FED) implements displaying through electron bombardment on phosphor. Having the same display principle as the traditional cathode ray tubes (CRT), FEDs have advantages in active luminescence, image quality, display speed, brightness, and resolution. Although CRTs have high power consumption and large volume for adopting thermionic cathodes, FEDs have low power consumption and can realize the flat-panel structure by introducing field-emission cold cathodes.

In prior art, the existing field emission displays currently have a triode structure, as shown in the FIG. 1, including cathode 3, gate electrode 4, and anode 6. Commonly, the cathode is a micro-tip-array, a thin-film, or a carbon nanotube cold cathode: The gate electrode 4 is prepared through micro-fabrication processing technique, or through screen-printing process. To fabricate a display device, firstly, cathode 3 is prepared on the substrate 1. Then the insulating layer 2 is prepared around cathode 3 and gate electrode 4 is prepared on insulating layer 2. Finally, substrate 1 and anode 6 are assembled to form a display device with insulation spacers 5. It can be seen that for the present technology, described above, is complex, which consequentially leads to high manufacturing cost.

### OBJECTIVE OF THE INVENTION

The Invention is about a multi-layer structure field emission display, whose fabrication process is simple, and whose performance is excellent.

### TECHNICAL SCHEMES OF THE INVENTION

The said multi-layer structure field emission display is composed of three separated plates, a cathode plate, a gate plate, and an anode plate. The three plates are separated and insulated from each other by solid insulating materials and have fixed distance from each other. Operation voltages are applied to the three plates. Using sealing materials, the whole multiple-layered display device can be sealed into an isolated space, whose internal gas can be pumped by a vacuum pump to form an internal vacuum space. Cathodes are prepared on the cathode plate, which work as electron emission sources. The said gate plate has arrays of apertures, which act as the channels limiting the electron trajectory. Gate electrodes are prepared on corresponding positions to gate apertures. The said anode plate is a glass plate covered by a conductive layer and a phosphor layer.

When the device is working, its whole interior is in vacuum. When a voltage is applied between one cathode row and one gate electrode column, electrons will be emitted out from the cathode, through the gate aperture, and bombard the anode. The bombardment of electrons on the phosphor layer will give out light and implement the displaying of pixels.

The multi-layer structure field emission display device structure in the invention simplifies the manufacturing process by assembling several plates together, on which the cathodes, the gate electrons, and the anodes are separately fabricated. Consequentially, the manufacturing cost will be reduced, and at same time, the focus electrodes can be built easily on the multiple-layer structure to focus the electron beams emitted by cathode and eliminate the inter-pixel crosstalk effectively.

### EXPLANATION OF THE DRAWINGS

FIG. 1: A structure of field emission display based on present technology

FIG. 2: A schematic structure of the multiple layered field emission display of current invention.

FIG. 3: The cross-section view of the multiple layered field emission display of current invention without focus electrodes. (a) is the schematic view for the multiple layered field emission display using the gate plate made of glass or ceramic material, (b) is the schematic view for the multi-layer structure field emission display using the gate plate made of metallic material.

FIG. 4: The cross-section view of the multi-layer structure field emission display with focus electrodes. (a) is the schematic view of the focusing electrode which is on the gate plate made of glass or ceramic material, (b) is the schematic view of the focusing electrode which is on the gate plate made of metallic material.

FIG. 5: The shapes of gate apertures of the multiple layered field emission display. (a) Round, (b) Oval, (c) Square, (d) Rectangular, (e) Strip.

FIG. 6: The display images for one pixel of the multi-layer structure field-emission display under different cathode currents. (a) is the image of 1 μA cathode current. (b) is the image of 3 μA cathode current; (c) is the display image of 10 μA cathode current.

FIG. 7: Showing the results of addressing test for different pixels of multi-layer structure field emission display.

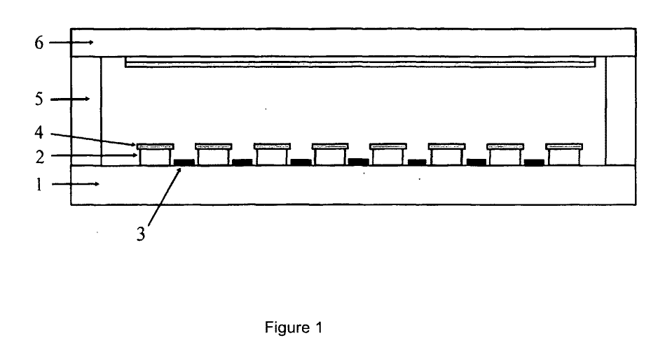

In these figures: Substrate - - - 1; Insulating Layer - - - 2, 18, 19; Cathode - - - 3, 9; Gate Electrode - - - 4; Insulation Spacer - - - 5; Anode - - - 6; Cathode Plate - - - 7; Cathode electrode - - - 8; Gate Electrode - - - 10; Gate Plate - - - 11; Gate Aperture - - - 12; Anode Plate - - - 13; Transparent Conducting Layer - - - 14; Phosphor Layer - - - 15; Insulator - - - 16; Focusing Electrode - - - 17; Insulating-film Layer - - - 18, 19.

### EMBODIMENTS

Combing with figures, the following contents give more detailed descriptions to the invention.

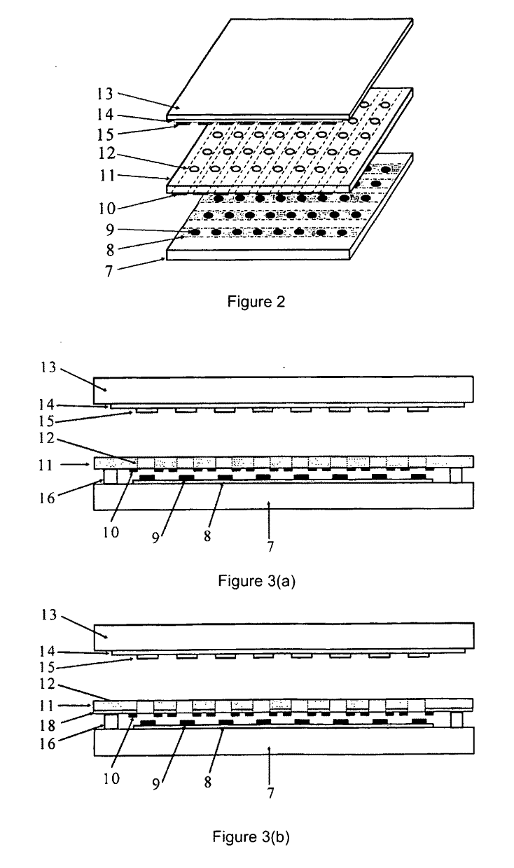

As shown in FIG. 2, the cathode plate 7 can be made of glass, ceramic, metals, or silicon. Firstly, for cathode plate made of glass or ceramic, conducting metallic electrodes or transparent conducting electrodes (for example, indium tin oxide, ITO for short) can be used as the cathode electrode 8, on which cathode 9 will be fabricated. Cathode 9 can be a micro-tip-array, a thin-film, carbon nanotube, metallic, or semiconducting nanomaterial cold cathode, like nanowires, nanobelts, and nanorods and so on. Secondly, for metallic or silicon plates, cathode 9, which can be micro-tip-array, thin-film, carbon nanotube, metallic or semiconducting nanomaterial cold cathode, such as nanowires, nanobelts, and nanorods and so on, can be prepared directly on them. The leads of cathode electrode 8 can be led out from one or two sides of the plate.

The gate plate 11 can be made of glass, ceramic, and metals. Firstly, the gate apertures can be prepared through machinery drilling, chemical corrosion, laser processing, or sandblast techniques. As shown in FIG. 5, the gate apertures can be in the shapes of round, oval, square, rectangular, or strip. As shown in FIG. 3 (a), for gate plates made of glass or ceramic, the gate electrode 10 shall be prepared at corresponding positions of gate apertures at the lower surface of the gate plate. Gate electrode 10 shall be in strip shape and made of metals through magnetron sputtering or electron beam evaporation technique, combined by photolithography technique, or directly printed through screen printing technique. Usually, the gate electrode 10 and cathode electrode 8 are perpendicular to each other. When high voltage and low voltage are applied to the gate and cathode electrode respectively, the cathode at the cross position of these two electrodes will emit electrons and implement the addressing of one pixel. The leads of gate electrode 10 can be led out from one or two sides of the plate.

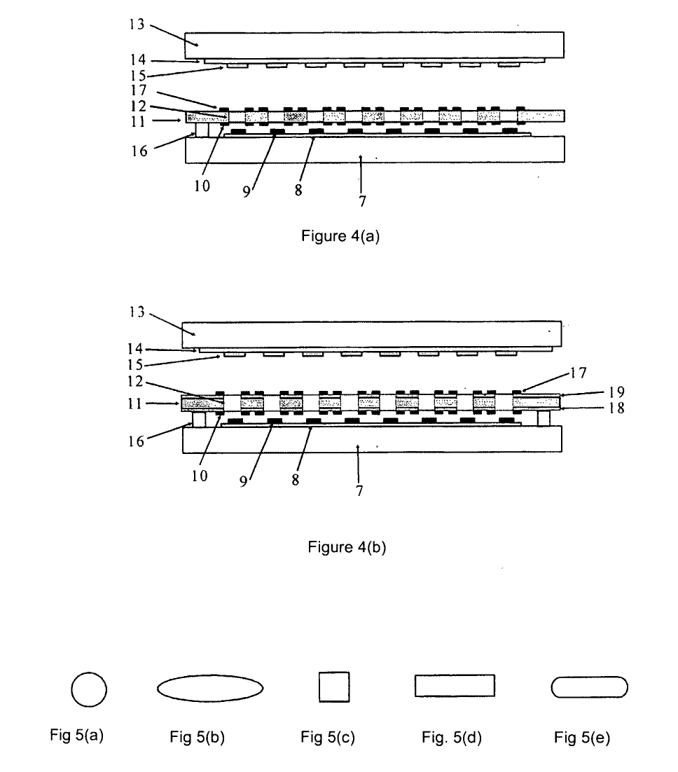

As shown in FIG. 4 (a), when the gate plate is made of glass or ceramic, focusing electrodes 17 can be fabricated at the corresponding positions to the gate apertures on the upper surface of the gate plate. The focusing electrodes can be a whole conducting layer. If the gate plate is made of metal, as shown in FIG. 4 (b), the metallic gate plate can act as focusing electrode. The focusing electrodes can also be in stripes. In that case, to build focusing electrodes on the metallic gate plate, an insulating layer 19 is first fabricated on the upper surface of the gate plate, and then the focusing electrodes 17 are prepared on insulating layer 19. Focusing electrode 17 shall be made of metal in strip shape, and prepared through magnetron sputtering or electron beam evaporation technique, combined by photolithography technique, or directly printed through screen printing.

The focusing electrode 17 and cathode electrode 8 are parallel or perpendicular to each other. The leads of focusing electrode strip 17 can be led out from one or two sides of the gate plate.

The anode plate 13 is made of glass. First a transparent conducting layer 14 (for example, indium tin oxide, ITO for short) is prepared on the glass plate first, and then a phosphor layer 15 in strips or points is prepared on the transparent conducting layer 14. For mono-color displays, the phosphor layer 15 can be also painted as a continuous layer. An alternative approach is that a phosphor layer is prepared first and an aluminum thin film is evaporated on it.

After the three plates are fabricated separately, they are assembled together and insulated from one another. During the assembling, the cathode, the gate aperture, and the phosphor pixel are aligned to one another. Sealant, such as low melting-point glass frit, is applied between the plates to fix and seal them. Solid Insulating spacers are used to insulate the three plates. Insulating spacers can be built on the plates at appropriate positions through screen printing technique to limit the distances between plates. Or, independent spacers made of insulating materials can be used and fixed by the pressure of plates, which also limit the intervals between plates.

Combining with FIG. 3, hereon, an embodiment will be introduced. Firstly, the glass cathode plate 7 is cleaned. Electron beam evaporation is used to deposit conducting ITO layer. The ITO cathode electrode 8 is fabricated through photolithography. On cathode electrode 8, carbon nanotube cathode 9 is prepared using screen printing technique.

The gate plate 11 is made of ceramic. Round gate apertures are prepared on the gate plate 12 through laser beam processing technique. Strips of chromium layer were fabricated using magnetron sputtering technique on the gate plate 11 through a shadow mask.

Conducting layer 14 of ITO is prepared using electron beam evaporation on glass anode plate 13. Strips of phosphors layer are then prepared on ITO conducting layer 14.

After the three plates described above all have been finished, layers of solid insulating material is applied among the three plates of gate, cathode, and anode to insulate them from each other. Low melting-point glass frit is applied to fix and assemble them. During the assembly, the cathode, gate electrode, and phosphor pixel are aligned to one another.

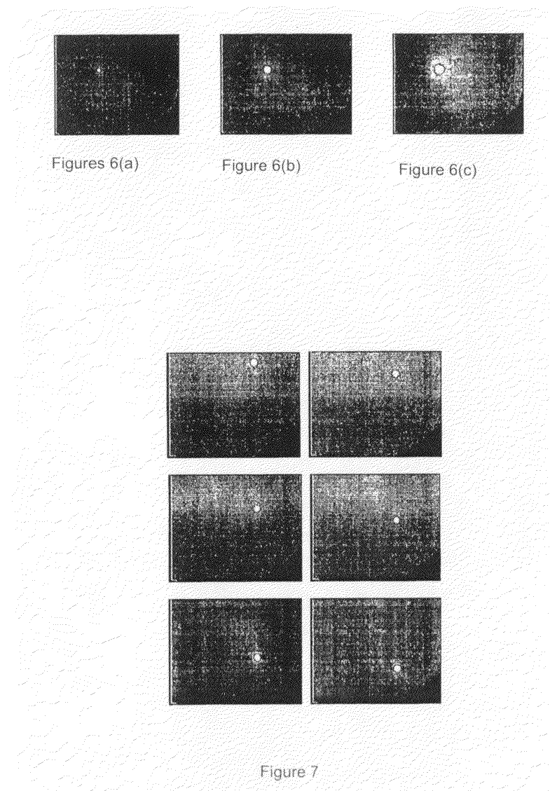

After the whole display device has been assembled together, the device is tested when the internal space is pumped to vacuum. After applying a voltage between one gate electrode column and one cathode row, electrons will be emitted from the cathodes, through the gate apertures to bombard the anode. The displaying of pixels can be achieved. FIG. 6 are the display images for one pixel of the multi-layer structure field-emission display of current invention under different cathode currents. Of which, FIG. 6(a) is the display image at 1 μA cathode current, FIG. 6(b) is the display image at 3 μA cathode current, FIG. 6(c) is the display image of 10 μA cathode current.

FIG. 7 shows the results of addressing test for different pixels of multiple layered field emission display. From it, one can see that individual pixel can be effectively addressed when voltage is applied to different gate and cathode electrodes.

Based on the technology of this invention, displays of various sizes can be manufactured using various size plates, and large displays can also be manufactured through combination of the small size plates. And the newly invented display device can be applied in various display terminals and televisions, especially in digital high definition televisions larger than 40 inch.

1. A field emission display having multi-layer structure, wherein:
comprising a cathode plate (7), a gate plate (11), and an anode plate (13); operating voltages being applied to the three plates; the three plates being insulated from each other by solid insulating materials and being fixed with certain intervals, being sealed and forming a vacuum space inside;
on said cathode plate (7), cathodes (9) which work as electron emission sources are prepared;
on said gate plate (11), gate apertures (12) which limit the electron trajectory are prepared, and gate electrodes (10) are prepared at the corresponding positions to the gate apertures;
said anode plate (13) is covered by a conductive layer (14) and a phosphor layer (15).

2. The field emission display having multi-layer structure of claim 1, wherein: the cathode plate (7), the gate plate (11), and the anode plate (13) are made of glass, ceramic, metal, or silicon.

3. The field emission display having multi-layer structure of claim 1, wherein: when the cathode plate (7) is made of metals or silicon, the cathode (9) can be directly prepared on it; when the cathode plate (7) is made of glass and ceramic, conducting metallic electrodes or transparent conducting electrodes are first prepared as cathode electrodes (8), and the cathodes (9) are prepared on the cathode electrodes (8).

4. The field emission display having multi-layer structure of claim 3, wherein: the cathode (9) is composed of one of the following categories: micro-tip-array, thin-film, carbon nanotube, metallic or semiconducting nanomaterial cold cathodes, for example, nanowires, nanobelts, and nanorods and so on.

5. The field emission display having multi-layer structure of claim 1, wherein: said gate apertures (12) can be round, oval, square, rectangular, and strip; the gate electrodes (10) mentioned are metallic electrodes in strip shape; the gate electrode strip and the cathode electrode (8) are perpendicular to each other.

6. The field emission display having multi-layer structure of claim 1, wherein: said gate plate (11) is an insulating plate.

7. The field emission display having multi-layer structure of claim 5, wherein: for gate plates (11) made of glass or ceramic, the strip gate electrode shall be built directly at the corresponding positions to gate apertures(12) at the lower surface of gate plate (11); for gate plates made of metals, an insulating layer (18) is first prepared on it, and then the conducting gate electrode (10) strips are prepared on the insulating layer, which are insulated from each other.

8. The field emission display having multi-layer structure of claim 5, wherein: for gate plates (11) made of glass or ceramic, focusing electrodes (17) can be prepared on corresponding positions to the gate apertures (12) on the upper surface of gate plate (11); for gate plates made of metals, the whole metallic gate plate can act as the focusing electrodes, or an insulating layer (19) is prepared on the upper surface of gate plate (11), and then focusing electrodes (17) are papered on the insulating layer (19); the focusing electrode (17) and cathode electrode (8) are parallel or perpendicular to each other.
